(19) United States
(12) Patent Application Publication
(10) Pub. No.: US 2016/0130845 A1
(43) Pub. Date: May 12, 2016

(54) OUTSIDE HANDLE DEVICE FOR VEHICLE

(71) Applicant: HYUNDAI MOTOR COMPANY, Seoul (KR)

(72) Inventor: Jung Hoon PARK, Yongin-si (KR)

(21) Appl. No.: 14/659,577

(22) Filed: Mar. 16, 2015

(30) Foreign Application Priority Data
Nov. 7, 2014 (KR) 10-2014-0154691

(51) Int. Cl. E05B 85/16

(52) U.S. Cl. CPC E05B 85/16

(57) ABSTRACT

An outside handle device for a vehicle includes: an outside handle housing mounted at an outer side of a door outer panel of the vehicle; a handle base mounted at an inner side of the door outer panel and coupled to the outside handle housing; a handle lever positioned at the inner side of the door outer panel to thereby be rotatably provided in the handle base and connected to the outside handle housing; and a backup lever positioned at the inner side of the door outer panel to thereby be rotatably provided in the handle base and selectively limiting rotation of the handle lever. Therefore, it is possible to prevent a door from being opened at the time of occurrence of a side collision to improve collision performance, thereby improving safety and salability.

### CROSS-REFERENCE TO RELATED APPLICATION

This application is based on and claims the benefit of priority to Korean Patent Application No. 10-2014-0154691, filed on Nov. 7, 2014 in the Korean Intellectual Property Office, the disclosure of which is incorporated herein in its entirety by reference.

### TECHNICAL FIELD

The present disclosure relates to an outside handle device for a vehicle, and more particularly, to an outside handle device for a vehicle capable of preventing an outside handle from being opened by changing a shape of a handle lever and allowing a backup lever to be rotated by inertia at the time of occurrence of a side collision to block rotation of the handle lever.

### BACKGROUND

Generally, a door for a vehicle hinge-coupled to a body to be opened and closed in order for a passenger to get in or get off the vehicle is configured to include a door inner panel, a door outer panel, a door trim coupled to the door inner panel and positioned at an indoor side, and a door glass ascending and descending by an operation of a regulator between the door inner panel and the door outer panel.

Here, the door outer panel is mounted with a door outside handle used at the time of opening a door from the outside, and the door inner panel is mounted with a door inside handle used at the time of opening the door from the inside.

Meanwhile, the door outside handle is configured to include a handle housing formed in a concave shape such as a bowl shape and fixed to the door outer panel and a handle lever hinge-coupled to the handling housing so as to be elastically rotatable with respect to the handle housing.

The handle lever is connected to a door latch through a latch cable. Therefore, when the handle lever is rotated with respect to the handle housing, the latch cable is pulled. In this case, the door is unlocked.

However, in the door outside handle according to the related art, since the door is unlocked when the handle lever is rotated with respect to the handle housing in a direction in which the latch cable is pulled, when a side collision accident occurs in a state in which a door locking switch is not operated, the handle lever is rotated by itself by inertial force, such that a undesired opening operation of the door is performed.

In addition, the rotation of the handle lever may be performed by a balance weight. However, a weight and a cost rise due to the balance weight, and further rise depending on a size of the handle.

### RELATED ART DOCUMENT

Patent 1: Korean Patent No. 10-0812439

### SUMMARY

The present disclosure has been made to solve the above-mentioned problems occurring in the prior art while advantages achieved by the prior art are maintained intact.

An aspect of the present disclosure provides an outside handle device for a vehicle capable of preventing an outside handle from being opened by changing a shape of a handle lever and allowing a backup lever to be rotated by inertia at the time of occurrence of a side collision to block rotation of the handle lever.

According to an exemplary embodiment of the present disclosure, an outside handle device for a vehicle includes: an outside handle housing mounted at an outer side of a door outer panel of the vehicle; a handle base mounted at an inner side of the door outer panel and coupled to the outside handle housing; a handle lever positioned at the inner side of the door outer panel to thereby be rotatably provided in the handle base and connected to the outside handle housing; and a backup lever positioned at the inner side of the door outer panel to thereby be rotatably provided in the handle base and selectively limiting rotation of the handle lever.

According to another exemplary embodiment of the present disclosure, a handle may include an outside handle housing, a handle base coupled to the outside handle housing, a handle lever coupled to the outside handle housing and provided at the handle base, and a backup lever provided at the handle base and being movable between a first position which allows the handle lever to rotate upon actuating the outside handle housing and a second position which blocks the handle level to rotate.

### BRIEF DESCRIPTION OF THE DRAWINGS

The above and other objects, features and advantages of the present disclosure will be more apparent from the following detailed description taken in conjunction with the accompanying drawings, in which:

FIG. 1 is an exploded perspective view showing an outside handle device for a vehicle according to an exemplary embodiment of the present disclosure;

FIG. 2 is a view showing the outside handle device for a vehicle according to an exemplary embodiment of the present disclosure;

FIG. 3 is a side view showing a handle lever and a backup lever in the outside handle device for a vehicle according to an exemplary embodiment of the present disclosure;

FIG. 4 is a view showing the handle lever and the backup lever in the outside handle device for a vehicle according to an exemplary embodiment of the present disclosure;

FIGS. 5A and 5B are views showing states before and after an operation of the backup lever in the outside handle device for a vehicle according to an exemplary embodiment of the present disclosure; and

FIGS. 6 to 10 are views showing operation steps of the outside handle device for a vehicle according to an exemplary embodiment of the present disclosure.

### DETAILED DESCRIPTION

An exemplary embodiment of the present disclosure will be described in detail with reference to the accompanying drawings.

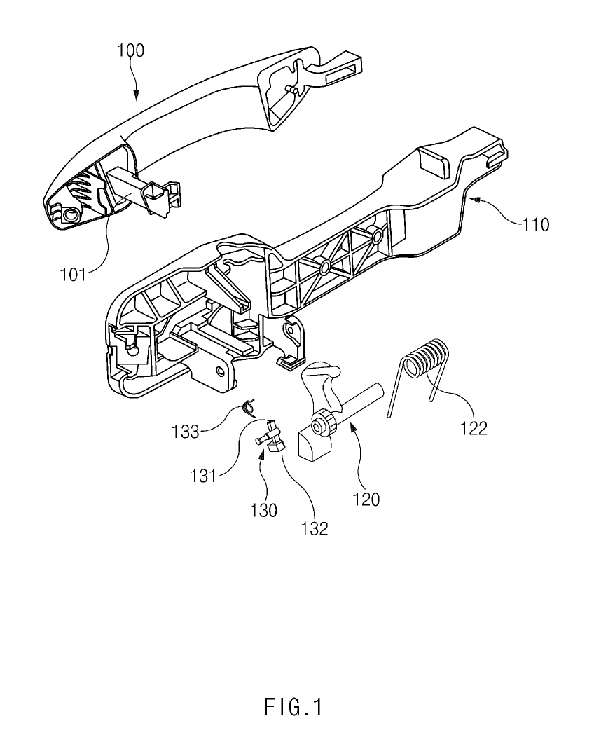

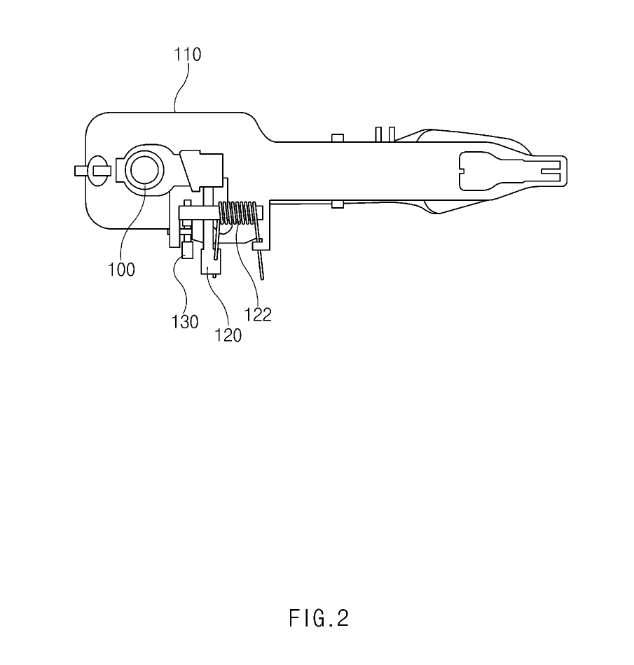

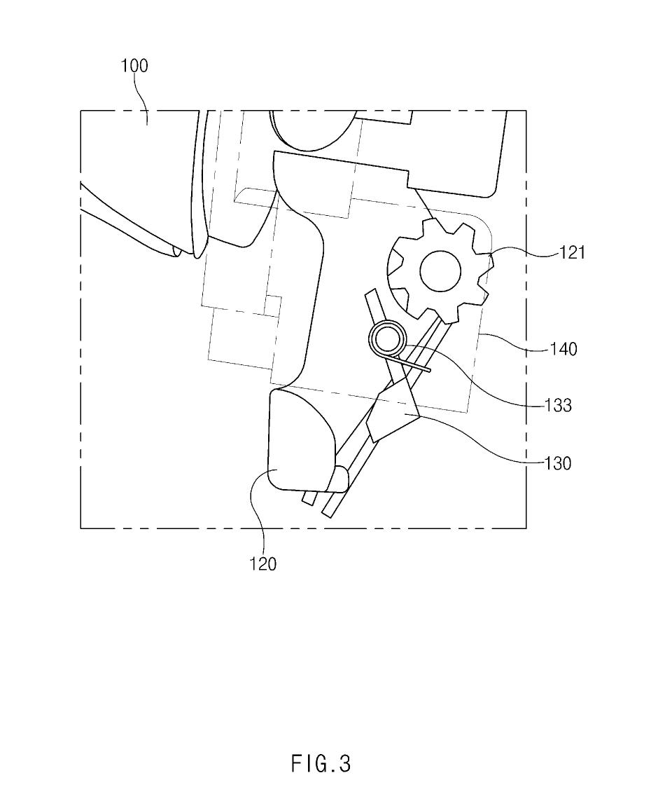

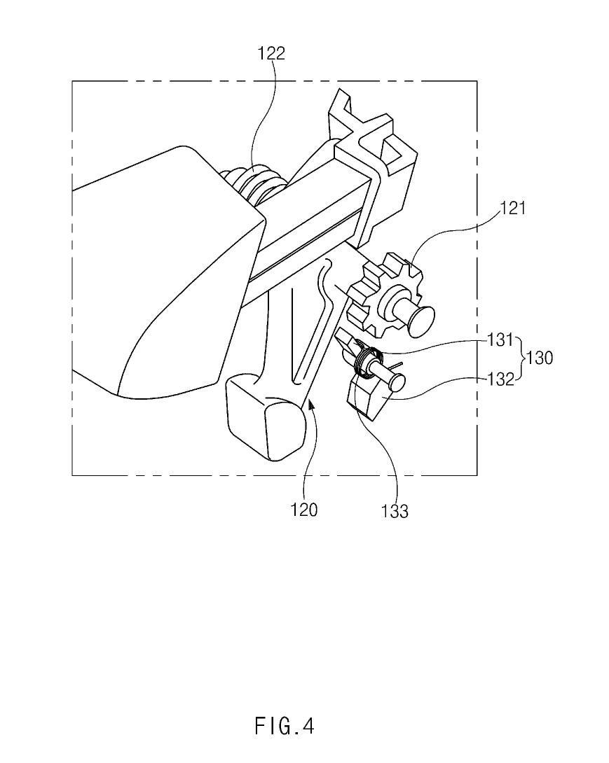

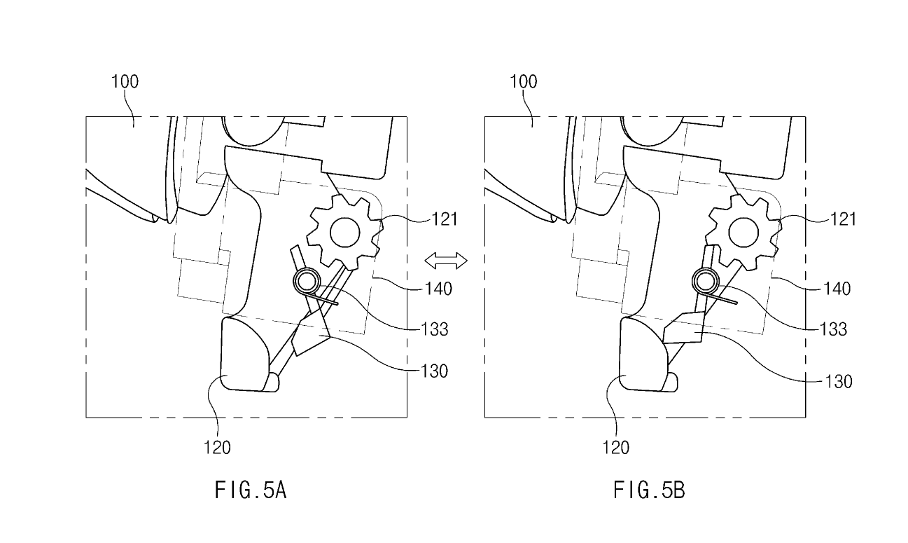

FIG. 1 is an exploded perspective view showing an outside handle device for a vehicle according to an exemplary embodiment of the present disclosure. FIG. 2 is a view showing the outside handle device for a vehicle according to an exemplary embodiment of the present disclosure. FIG. 3 is a side view showing a handle lever and a backup lever in the outside handle device for a vehicle according to an exemplary embodiment of the present disclosure. FIG. 4 is a view showing the handle lever and the backup lever in the outside handle device for a vehicle according to an exemplary embodiment of the present disclosure. FIGS. 5A and 5B are views showing states before and after an operation of the backup lever in the outside handle device for a vehicle according to an exemplary embodiment of the present disclosure. As shown in FIGS. 1 through 5B, an outside handle device for a vehicle according to an exemplary embodiment of the present disclosure is configured to include an outside handle housing 100 mounted on a door outer panel, a handle base 110 coupled to the outside handle housing 100, a handle lever 120 connected to the outside handle housing 100 and rotatable, and a backup lever 130 limiting rotation of the handle lever 120 and rotatable.

As shown in FIGS. 1 and 2, the outside handle housing 100 is mounted at an outer side of the door outer panel of the vehicle and is slid in left and right directions or is pushed or pulled in front and rear directions to open or close a door.

The handle base 110 is mounted at an inner side of the door outer panel, and allows the outside handle housing 100 mounted thereon to be fixed thereto.

Here, it is preferable that the outside handle housing 100 includes a connection member 101 penetrating through the handle base 110 to improve fixing force between the outside handle housing 100 and the handle base 110.

As shown in FIGS. 1 and 3, the handle lever 120 is positioned at the inner side of the door outer panel to thereby be rotatably provided in the handle base 110 and has one end connected to the outside handle housing 100 to allow operation force to be transferred to a door latch through the handle lever 120 in the case in which a user operates the outside handle housing 100.

Here, it is preferable that the handle lever 120 is coupled to the connection member 101 of the outside handle housing 100 penetrating through the handle base 110, such that coupling force between the outside handle housing 100 and the handle lever 120 is improved, thereby allowing the operation force of the outside handle housing to be appropriately transferred to the door latch through the handle lever 120.

In addition, it is preferable that the handle lever 120 includes a gear part 121 having a plurality of gears formed on an outer peripheral surface thereof to correspond to a backup lever 130 to be described below.

The backup lever 130 is positioned at the inner side of the door outer panel to thereby be rotatably provided in the handle base 110 and selectively limit the rotation of the handle lever 120.

Here, as shown in FIGS. 3 to 5B, it is preferable that a bar 131 limiting rotation of the gear part 121 formed in the handle lever 120 is formed at one end of the backup lever 130.

Meanwhile, in the present disclosure, even though the handle lever 120 first is rotated by a side collision, an opportunity to contact the bar 131 of the backup lever 130 may be again provided by the plurality of gears formed in the gear part 121 of the handle lever 120 to raise the possibility that the limitation for the rotation of the handle lever 120 through the backup lever 130 will succeed, thereby making it possible to improve safety of vehicle passengers.

In addition, it is preferable that a weight body 132 is formed at the other end of the backup lever 130 to facilitate rotation of the backup lever 130 at the time occurrence of the side collision. The weight body 132 may have a density greater than the bar 131 and/or have a size greater than the bar 131 so as to provide a relatively large weight or force of gravity.

Here, as shown in FIGS. 1 and 3, the handle lever 120 includes a handle elastic body 122 so as to be rotatable and restorable. The handle elastic body 122 is also rotated together with the handle lever 120 in the case in which the handle lever 120 is rotated by an operation of the outside handle housing 100, and the handle lever 120 is restored to its original position by elastic force of the handle elastic body 122 in the case in which the operation of the outside handle housing 100 is canceled. The handle elastic body 122 may be a spring.

In addition, as shown in FIGS. 1 and 3, the backup lever 130 also includes a backup elastic body 133 so as to be rotatable and restorable. The backup elastic body 133 is rotated together with the weight body 132 at the time of the occurrence of the side collision, and the backup lever 130 is restored to its original position by elastic force of the backup elastic body 133 at the time of releasing the operation. The backup elastic body 133 may be a spring.

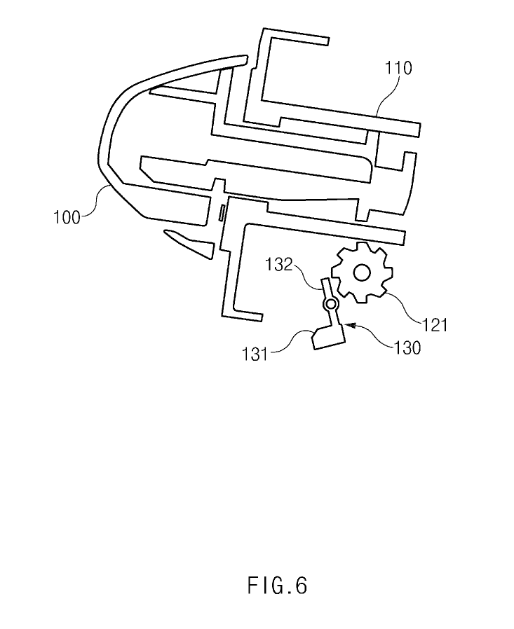

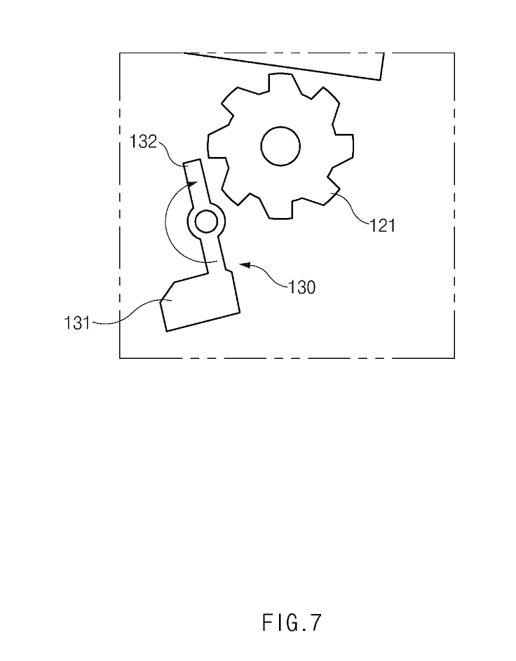

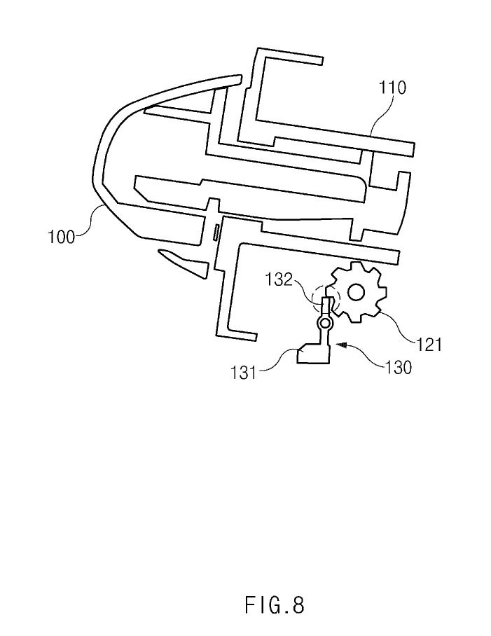

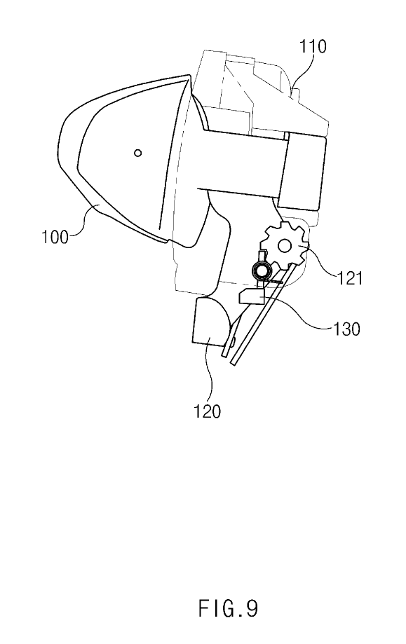

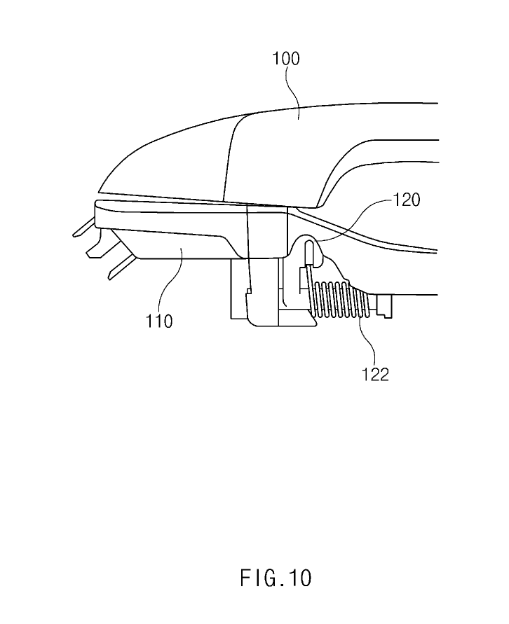

As described above, in the present disclosure, as shown in FIG. 6, the weight body 132 formed at a lower portion of the backup lever 130 moves in (1) direction at the time of the occurrence of the side collision of the vehicle. Then, as shown in FIG. 7, the backup lever 130 is rotated in (2) direction by inertial movement of the weight body 132. As a result, as shown in FIG. 8, the bar 131 of the backup lever 130 latches the gear part 121 of the handle lever 120 by the rotation of the backup lever 130 to block the rotation of the handle lever 120. Therefore, as shown in FIGS. 9 and 10, the operation of the outside handle housing 100 is blocked by an inertial action at the time of the side collision to prevent the door to be opened, such that collision performance is improved, thereby improving safety and salability.

As described above, according to an exemplary embodiment of the present invention, it is possible to prevent the door from being opened at the time of the occurrence of the side collision to improve the collision performance, thereby improving the safety and the salability.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An outside handle device for a vehicle, comprising:
an outside handle housing mounted at an outer side of a door outer panel of the vehicle;
a handle base mounted at an inner side of the door outer panel and coupled to the outside handle housing;
a handle lever positioned at the inner side of the door outer panel to thereby be rotatably provided in the handle base and connected to the outside handle housing; and
a backup lever positioned at the inner side of the door outer panel to thereby be rotatably provided in the handle base and selectively limiting rotation of the handle lever.

2. The outside handle device for a vehicle according to claim 1, wherein the outside handle housing includes a connection member penetrating through the handle base.

3. The outside handle device for a vehicle according to claim 2, wherein the connection member and the handle lever are coupled to each other.

4. The outside handle device for a vehicle according to claim 1, wherein the handle lever includes a gear part having a plurality of gears formed on an outer peripheral surface thereof.

5. The outside handle device for a vehicle according to claim 4, wherein the backup lever is provided with a bar limiting rotation of the gear part.

6. The outside handle device for a vehicle according to claim 5, wherein the backup lever has a weight body formed at the other end of the bar.

7. The outside handle device for a vehicle according to claim 1, wherein the handle lever includes a handle elastic body so as to be rotatable and restorable.

8. The outside handle device for a vehicle according to claim 1, wherein the backup lever includes a backup elastic body so as to be rotatable and restorable.

9. A handle, comprising:
an outside handle housing;
a handle base coupled to the outside handle housing;
a handle lever coupled to the outside handle housing and provided at the handle base; and
a backup lever provided at the handle base and being movable between a first position which allows the handle lever to rotate upon actuating the outside handle housing and a second position which blocks the handle level to rotate.

10. The handle of claim 9, wherein the backup level comprises a backup elastic body, a bar, and a weight body connected to an end of the bar,
wherein the handle lever includes a gear part having a plurality of gears, and
wherein the bar of the backup lever is coupled to the gear part at the second position.

11. The handle of claim 9, wherein the outside handle housing includes a connection member penetrating through the handle base.

12. The handle of claim 9, wherein the handle lever includes a handle elastic body so as to be rotatable and restorable.
